(19) United States
(12) Patent Application Publication
(10) Pub. No.: US 2005/0271260 A1
(43) Pub. Date: Dec. 8, 2005

(54) Device, method and program for removing pores

(75) Inventor: Masanori Hara, Tokyo (JP)

Correspondence Address: FOLEY AND LARDNER;SUITE 500, 3000 K STREET NW, WASHINGTON, DC, 20007, US

(73) Assignee: NEC Corporation

(21) Appl. No.: 11/140,063

(22) Filed: May 31, 2005

(30) Foreign Application Priority Data
Jun. 1, 2004 (JP) 2004-162818

(51) Int. Cl. G06K 9/00; G06K 9/40

(52) U.S. Cl. 382/124; 382/254

(57) ABSTRACT

To remove pores stably even in a gray image of low quality. A ridge density threshold calculating means calculates the threshold of a density value considered as a ridge based on a fingerprint image density. A pore extracting means compares and evaluates densities of a group of nearby pixels around a target pixel, and extracts pixels, inside a group of pixels regarded as ridge pixels, as a group of pore pixels. A pore selecting means inspects the pores extracted by the pore extracting means, and selects only appropriate pores. A pore removing means performs fill-in processing to a group of pore pixels selected by the pore selecting means, and if the result is appropriate as a fingerprint ridge, adopts the result.

### BACKGROUND OF THE INVENTION

1. Field of the Invention

The present invention relates to a pore removing device and the like for removing pores from fingerprint images in a fingerprint collating technique.

2. Related Art

Conventionally, fingerprint collation is performed by collating minutiae using endings and bifurcations of fingerprint ridges (collectively referred to as fingerprint minutiae). In this case, if a fingerprint image is in a poor image quality and includes pores prominently, there is caused a problem that the performance of extracting minutiae is deteriorated due to an influence of the pores, whereby the collating accuracy is also degraded.

In order to solve this problem, there is known a technique for preventing influence of pores by detecting the pores using a binary image acquired on the way of extraction processing of minutiae. Generally, a binary image is an image represented by two values, that is, a ridge part is represented by 1 (which means black) and a valley or a base pattern is represented by 0 (which means white). Further, there is also a technique using skeleton data in which a binary image is further made into fine lines. However, in these techniques, if a binary image includes errors, for example, if it is a gray image with low quality, the binary image cannot represent ridge parts accurately, so the accuracy of removal processing of pores is low.

On the other hand, there is another technique for preventing influence of pores by detecting the pores not using a binary image but using a gray image. For example, Japanese Patent Application Laid-open No. 5-205035 (Patent Document 1) discloses a technique in which contours are extracted from a gray image, and those satisfying the conditions among loop contours are considered as pores, and the gray image is corrected so as to remove the pores. Further, Japanese Patent Application Laid-open No. 2001-14464 (Patent Document 2) discloses a technique in which smoothing processing is performed with a longitudinal strip filter along a ridge direction with respect to a gray image to thereby remove continuous pores.

However, in the technique of Patent Document 1, when loop contours are extracted, some pores may not be shown as loop contours if the gray image is in low quality. Therefore, there has been a limitation in the accuracy of removing pores. For example, in a pore shown in FIG. 16[1], the density values of pixels in a square at the obliquely right upper part are low, so it was difficult to extract loop contours having the similar density values. Further, in a roughly digitized gray image of typical 500 dpi or so, a pore is not shown as a fine circle, whereby it was difficult to determine loop contours.

Further, in the technique of Patent Document 2, when the smoothing processing is performed along the ridge direction, there has been a problem that a narrow valley is perceived as continuous pores in error in the case of a gray image of low quality as shown in FIG. 16[2].

### SUMMARY OF THE INVENTION

It is therefore an object of the present invention to provide a pore removing device and the like, capable of removing pores stably even in a gray image of low quality.

A pore removing device according to the present invention is to remove pores from a fingerprint gray image when extracting minutiae from the fingerprint gray image, and includes a ridge pixel detecting means and a pore judging means. The ridge pixel detecting means detects the presence of a ridge pixel in each radial direction from a target pixel as a center thereof based on a density change, with respect to a group of pixels in a certain area including the target pixel within the fingerprint gray image. The pore judging means considers, according to the result detected by the ridge pixel detecting means, the ridge pixel, if any, as a peripheral pixel, and if there is no ridge pixel, considers such a direction as an open direction defined by a valley, and based on the total number of the open directions, judging whether the target pixel is a pore.

In general, a pore is surrounded by ridge pixels with high density values, so in an image of high image quality, it is possible to extract a pore by searching for pixels with low density values surrounded by pixels with high density values. However, if the image quality is low, a part of ridge pixels shows a low density value, so a pore may not be completely surrounded by a group of pixels with high density values. Even in such a case, the present invention can inspect pixel densities in a wider range by inspecting density changes in radial directions, so it is possible to extract a pore accurately even when the image quality is low.

Further, the ridge pixel detecting means may detect a pixel with a density level not less than a certain level as a ridge pixel, or when the density change shows a density value peak in which the density value once increases along the direction and then decreases, the ridge pixel detecting means may detect a pixel with the density value peak as a ridge pixel.

The pore judging means may judge the target pixel as a pore if the total number of the open directions is zero or not more than a certain number.

The pore removing device according to the present invention may further include a pore removing means. When the target pixel is judged as a pore by the pore judging means, the pore removing means considers a pixel inside the peripheral pixels as a pore pixel, and replaces the density of the pore pixel with a density close to the densities of the peripheral pixels. At this time, the pore removing means may replace the density of the pore pixel with an average value of the weighted densities of the peripheral pixels, the weighting being heavier as a distance to the target pixel is shorter. Further, after the density of the pore pixel is replaced, the pore removing means may restore the replaced density if an area regarded as a ridge pixel has not less than a certain width.

The pore removing device according to the present invention may further include a ridge direction detecting means for detecting ridge directions. At this time, the pore judging means judges the target pixel as a pore if an acute angle defined by the ridge direction detected by the ridge direction detecting means and the open direction is not less than a certain angle.

A pore removing method according to the present invention is so configured that respective means of the pore removing device of the present invention are replaced with steps. A pore removing program according to the present invention is to prompt a computer to execute respective means of the pore removing device according to the present invention.

Further, the present invention is characterized as to include a means for extracting and removing pores studded on ridges with high performance in order to extract minutiae of a fingerprint image, and provides a configuration to improve the accuracy of minutia extraction. For example, the density changes are inspected radially from a target pixel by using a mask pattern in 72 directions, and if there are pixels satisfying predetermined conditions, the pixels are determined as outer peripheral pixels. If outer peripheral pixels are not determined, such directions are determined as open directions, and a pore is extracted based on the presence of open directions. Further, the inner angle (acute angle) between an open direction and a ridge direction is inspected, and if the inner angle is larger than a predetermined threshold, the pixel is extracted as a pore even though there is an open direction.

Further, the present invention may be so configured that, in the pore removing processing in the configuration of extracting minutiae from a fingerprint image, it is inspected whether there is a ridge pixel to come across based on the density change in radial directions from the center pixel, and if there is such a ridge pixel, it is considered as a peripheral pixel, and if there is no such a ridge pixel, such a direction is considered as an open direction; and it is judged whether the pixels show a pore based on the presence of open directions for one circumference, and if it is determined as a pore, a pixel inside the peripheral pixels is determined as a pore pixel, and the density value of the pore pixel is replaced with the weighted average of the peripheral pixel densities, whereby the pore is removed.

Further, as a density change detection, the present invention includes a means for inspecting pixels outside the center pixel, and detecting a density value peak in which the density value once increases and then decreases. When such a peak is detected, the pixel is determined as a ridge pixel.

Further, as a result of inspecting whether to come across ridge pixels radially, a direction not coming across a ridge pixel is registered as an open direction, and if the open direction is not in parallel with the ridge direction, it is determined as a pore.

Further, the pore removing means calculates a weighted average of nearby ridge pixel density values in which an inverse number of a distance between a target pixel and each nearby ridge pixel is used as weighting, and sets the weighted average as the density value of the target pore to thereby create a natural image, in which a pore is removed and densities change smoothly.

Further, the pore removing means inspects the image after removing a pore, and if an area regarded as a ridge pixel has a width not less than a certain width, discards the pore removal processing and restores the image to the original one.

(Effects)

A first effect of the present invention is to enable extraction of pores accurately by means of an easy method of inspecting density changes in radial directions even in a gradation fingerprint image of low image quality.

A second effect of the present invention is to enable extraction of pores accurately even in a fingerprint image scanned in 500 dpi resolution or the like typically adopted, by adopting a radial mask appropriate for such a resolution.

A third effect of the present invention is not to depend on the accuracy of binarizing or thinning, since pores are extracted and removed directly from a gray image. Methods using a binary image or skeleton data, adopted typically in conventional art, depend on the accuracy of binarizing or thinning, so if the extraction accuracy of the binary image or the skeleton data is low, the accuracy of removing pores is also low.

A fourth effect of the present invention is to enable removal of pores in a fingerprint image of low quality in which a part of a pore wall is cut away, because even when open directions are detected in the radial inspection, a pixel is considered as a pore if the inner angle between the open direction and the ridge direction has a certain degree of angle.

A fifth effect of the present invention is to enable to create a natural image in which pores are removed and densities change smoothly, by calculating a weighted average of nearby ridge pixel density values in which an inverse number of a distance between a target pixel and each nearby ridge pixel is used as weighting, and by setting the weighted average as the density value of the target pore, as pore removing processing.

A sixth effect of the present invention is to enable to suppress inappropriate pore removing processing by inspecting the image after removing pores, and if an area regarded as ridge pixels has a width not less than a certain width, the pore removal processing is discarded and the image is restored to the original one.

### BRIEF DESCRIPTION OF THE DRAWINGS

FIGS. 1[1] and 1[2] show a first embodiment of a pore removing device according to the present invention, in which FIG. 1[1] is a block diagram, and FIG. 1[2] is a flowchart;

FIG. 2 is a block diagram showing a fingerprint minutia extracting device in which the pore removing device of FIG. 1[1] is used;

FIG. 3 is an illustration showing an exemplary fingerprint (gray image) in which pores are prominent;

FIG. 4 is a flowchart showing processing of extracting a candidate pore by using a radial mask in the first embodiment;

FIG. 5 in an illustration showing exemplary pores in the first embodiment;

FIGS. 6(a) and 6(b) are diagrams showing an exemplary radial mask pattern (24 directions) in the first embodiment, in which FIG. 6(a) shows identification codes of constituent pixels, and FIG. 6(b) shows definitions of radial directions;

FIG. 7 is a diagram showing an exemplary radial mask pattern (72 directions) in the first embodiment,

FIGS. 8(a) and 8(b) are diagrams showing an exemplary radial mask pattern (72 directions) in the first embodiment, in which FIG. 8(a) shows identification codes of constituent pixels, and FIG. 8(b) shows definitions of radial directions;

FIG. 9 is a diagram showing density conditions near pores in the first embodiment;

FIGS. 10(a) to 10(e) are diagrams showing density values and processing results of pores in the first embodiment, in which processing is proceeded in the order from FIG. 10(a) to FIG. 10(e);

FIG. 11 is a flowchart showing pore removal and validation in the first embodiment;

FIGS. 12[1] and 12[2] show a second embodiment of a pore removing device according to the present invention, in which FIG. 12[1] is a block diagram, and FIG. 12[2] is a flowchart;

FIG. 13 is an illustration showing exemplary ridge directions in the second embodiment;

FIG. 14 is an illustration showing directional patterns of ridges in the second embodiment;

FIGS. 15(a) to 15(e) are diagrams showing density values and processing results of pores of the second embodiment, in which processing is proceeded in the order from FIG. 15(a) to FIG. 15(e); and

FIG. 16[1] is an illustration showing an exemplary zoom-up of a pore, and FIG. 16[2] is an illustration showing an exemplary valley which is liable to be misidentified as a pore.

### PREFERRED EMBODIMENTS OF THE INVENTION

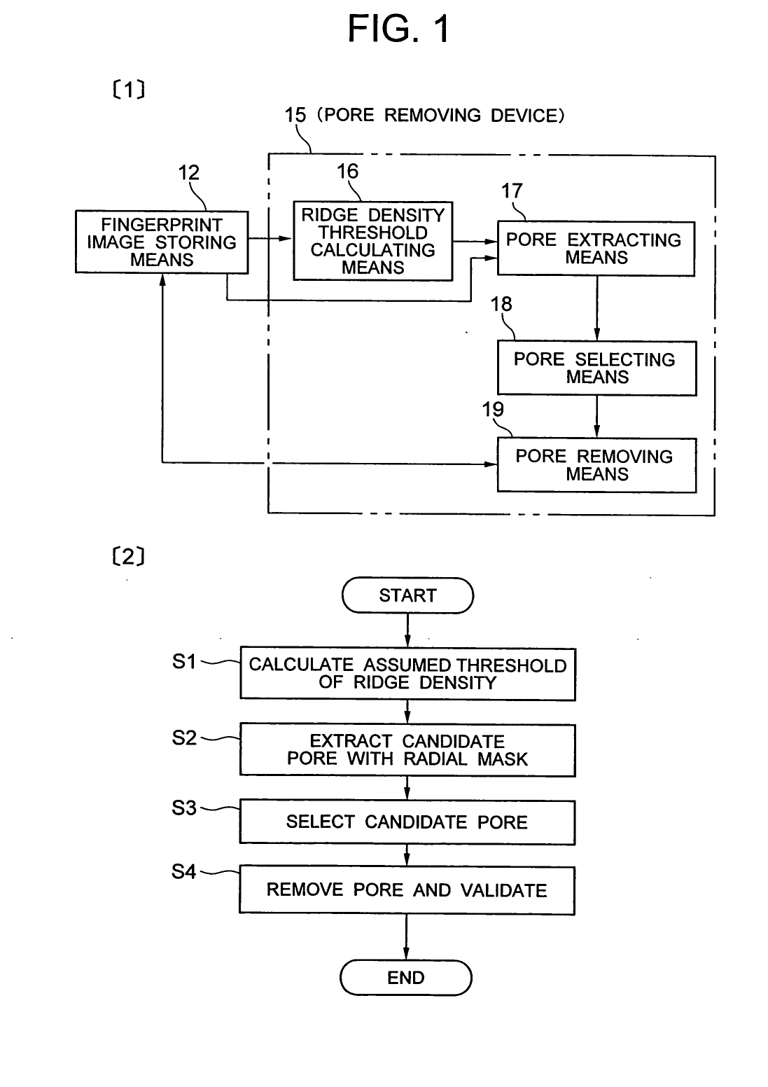

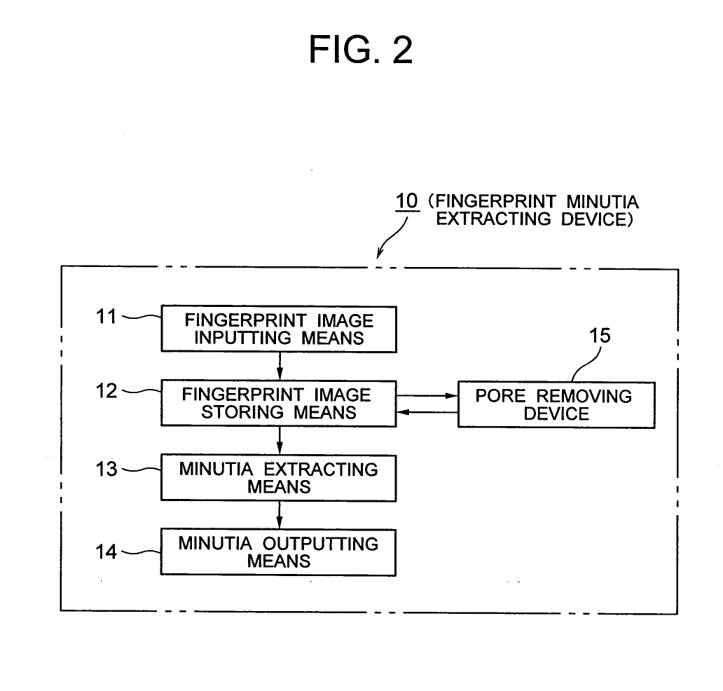

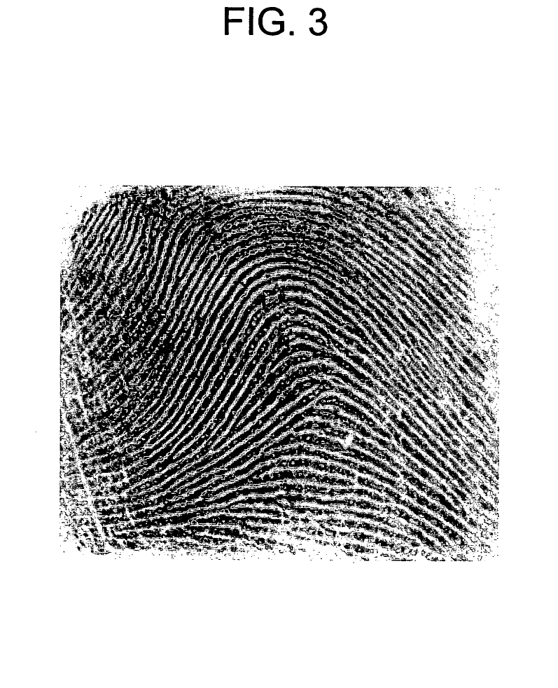

FIGS. 1[1] and 1[2] show a first embodiment of a pore removing device according to the present invention, in which FIG. 1[1] is a block diagram, and FIG. 1[2] is a flowchart. FIG. 2 is a block diagram showing a fingerprint minutia extracting device in which the pore removing device of FIG. 1 is used. FIG. 3 is an illustration showing an example of a fingerprint image. Hereinafter, explanation will be given referring mainly to these drawings.

As shown in FIG. 2, a fingerprint minutia extracting device 10 includes: a fingerprint image inputting means 11 for digitizing and inputting a fingerprint image read out by a fingerprint sensor or a scanner; a fingerprint image storing means 12 for temporarily storing the fingerprint image inputted by the fingerprint image inputting means 11; a pore removing device 15 for extracting and removing pores from a fingerprint image stored on the fingerprint image storing means 12; a minutia extracting means 13 for extracting minutiae from the fingerprint image in which pores are removed by the pore removing device 15 and which is stored on the fingerprint image storing means 12; and a minutia outputting means 14 for outputting minutia data extracted by the minutia extracting means 13.

The fingerprint image inputting means 11 digitizes a fingerprint image read out by a fingerprint sensor or a scanner, and temporarily stores it on the fingerprint image storing means 12. FIG. 3 shows an exemplary fingerprint image digitized in 500 dpi resolution, in which pores are prominent. This is digitized in accordance with ANSI/NIST-CSL-1-1993 Data Format for the Interchange of Fingerprint, Facial & SMT Information standardized by National Institute of Standards and Technology. In the present embodiment, a fingerprint image digitized in this manner is described as an example. In this standard, representation of density value is defined on the brightness basis in which the value increases as the brightness becomes larger (brighter). However, in the present embodiment, representation of density value is described on the density basis in which the value increases as the density becomes higher (darker). Therefore, a high-dense ridge part is close to the maximum value of 255, and the base pattern or a valley of low density becomes to have a density value close to 0.

The minutia extracting means 13 extracts minutiae of fingerprints such as endings and bifurcations from gray image data. The minutia extraction processing is realized by using such known art as described in Japanese Examined Patent Publication No. 60-12674, “PATTERN FEATURES EXTRACTING DEVICE” (ASAI), and it's US counterpart, that is, U.S. Pat. No. 4,310,827, Device for extracting a density as one of pattern features for each feature point of a streaked pattern (Asai).

The minutia output means 14 outputs minutia data extracted by the minutia extracting means 13 to a subsequent processing means. Typically, in the subsequent processing, if an input image is on the file side (registration purpose), it is registered in a database, and if an input image is on the search side (inquiry purpose), it is utilized for minutia collation.

As shown in FIG. 1[1], the pore removing device 15 of the present embodiment includes a ridge density threshold calculating means 16, a pore extracting means 17, a pore selecting means 18 and a pore removing means 19, and the device 15 extracts and removes pores from an fingerprint image stored on the fingerprint image storing means 12. Note that the pore extracting means 17 serves as: a ridge pixel detecting means for detecting presence of ridge pixels in respective radial directions from the target pixel as the center based on the density change, with respect to a group of pixels in a certain area including a target pixel within a fingerprint gray image; and a pore judging means for, based on the result detected by the ridge pixel detecting means, considering the ridge pixels, if any, as peripheral pixels, and if there is no ridge pixel, considering such a direction as an open direction defined by a valley, and based on the number of open directions, judging whether the target pixel is a pore. Further, respective means of the pore removing device 15 are realized on a computer by programs.

The ridge density threshold calculating means 16 calculates the threshold of a density value regarded as a ridge based on the fingerprint image density near the target pixel, by a small area unit. The pore extracting means 17 uses a predetermined radial mask so as to comparatively evaluate the densities of a nearby group of pixels around the target pixel radially, and judges whether to come across pixels regarded as ridges in respective directions, and records directions not coming across the ridge pixels as open directions to thereby extract the inner side of the group of pixels regarded as ridge pixels as a group of pore pixels. The pore selecting means 18 inspects the pores extracted by the pore extracting means 17, and selects only appropriate pores according to the presence of open directions and the conditions. The pore removing means 19 performs fill-in processing to the group of pores pixels selected by the pore selecting means 18, and if the result is appropriate as a fingerprint ridge, adopts the result, and if the result is inappropriate, discards the result.

The general operation of the pore removing device 15 is shown in FIG. 1[2]. First, in step S1, an assumed threshold of a ridge density is calculated. This calculation is performed by the ridge density threshold calculating means 16. Although various methods of calculating a threshold to binarize fingerprint density image have been proposed, one example in which calculation can be performed easily will be explained below.

The density distribution of pixels within 10-pixel radius from the target pixel as the center is examined. The radius length of 10 pixels is defined as a distance similar to an average ridge width such that a fingerprint ridge and a valley must be included in the inspection range. Experience shows that in a fingerprinted area, the area occupied by fingerprint ridges is in a range between about 20% and 80%, although it differs depending on parts where fingerprint ridges are dense or non-dense.

Now, a histogram is calculated in an area of 10-pixel radius, and assuming that a density obtained by subtracting 20% of a histogram cumulative value from the white density is ThW, and a density obtained by subtracting 20% of a histogram cumulative value from the black density is ThB, the two threshold values ThH and ThL are set as follows:
ThH=(ThW+ThB)/2
ThL=(ThW*9+ThW*1)/10

The meanings of the two threshold values ThH and ThL will be explained. The threshold value ThH is a threshold by which a pixel having a density value larger than the threshold value is determined as a ridge pixel. In the present embodiment, ThH is set as an intermediate value between ThW and ThB. Further, the threshold value ThL is a threshold by which a pixel having a density value smaller than the threshold value is determined as not a ridge value. In the present embodiment, ThL is set as a value more close to ThW than the intermediate value between ThW and ThB. Further, a pixel in which the density is larger than ThL but smaller than ThH is determined to have a possibility of being a ridge pixel, so the pixel is subject to a more detailed pore inspection.

Although this calculation is simple, the amount of calculation increases if it is performed to all pixels. To cope with this, if one representative pixel is set per small area unit such as 4*4 pixels or 8*8 pixels, and a ridge density threshold thereof is applied to all pixels within the small area, it is possible to reduce the amount of calculation significantly and is also practical.

A ridge density threshold calculated in this manner is recorded as a table which can be searched from a pixel coordinate, and is outputted to the subsequent processing.

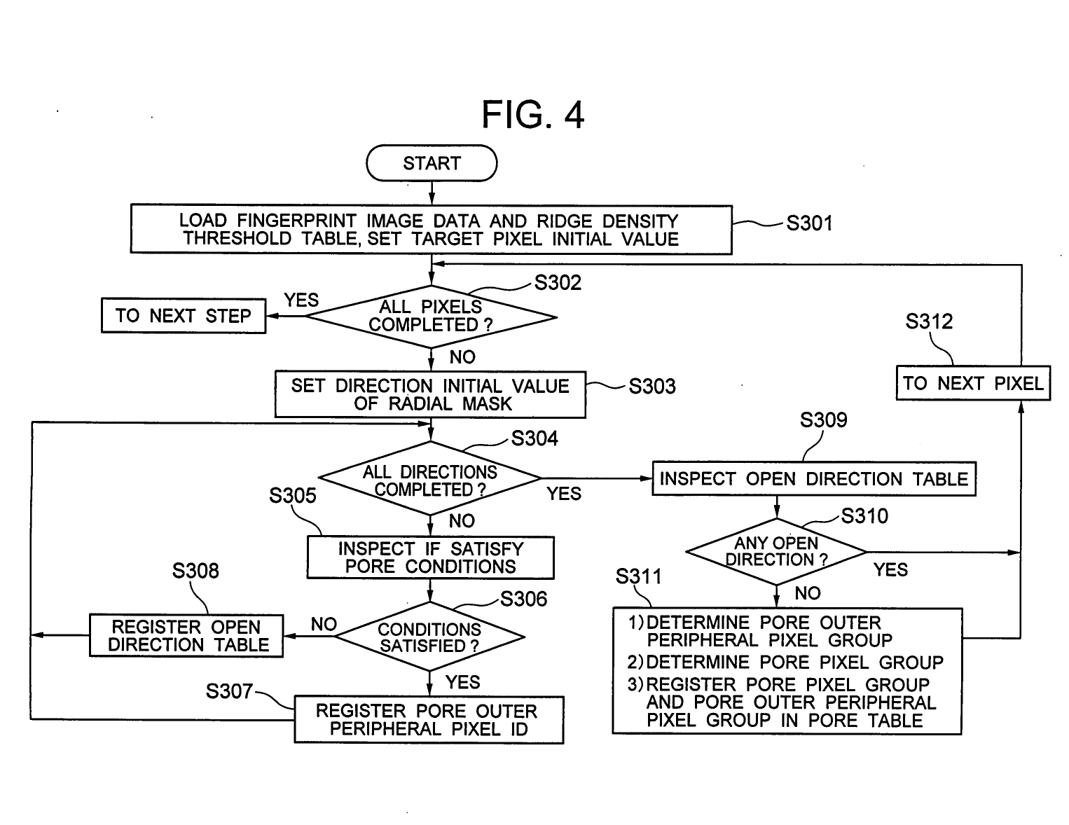

Next, in step S2, a pore is extracted by using a radial mask. This extraction is performed by the pore extracting means 17 shown in FIG. 1[1]. The pore extraction is processing to extract a group of pore pixels by using a predetermined radial mask, which is the core processing in the present invention, so it will be described in detail by using a flowchart shown in FIG. 4.

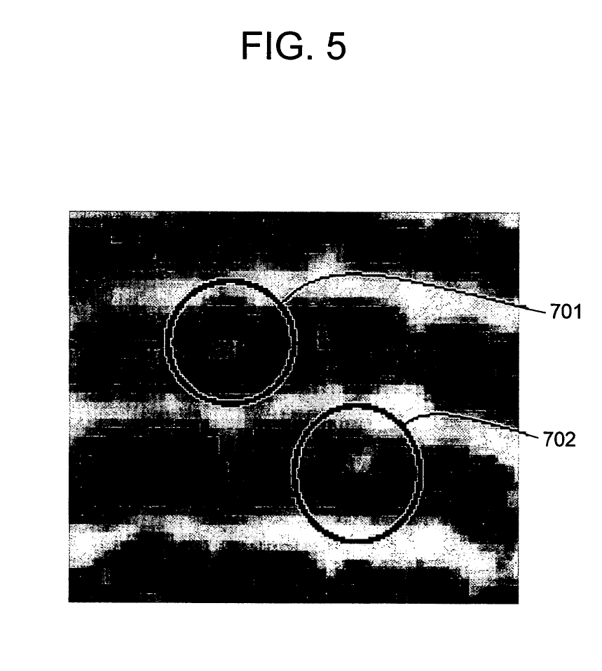

First, a brief explanation will be given for pores. Pores are collapsed holes studded on fingerprint ridges. They are shaped like circles actually. However, in a scanned image of 500 dpi resolution adopted typically, the shapes are less likely to be circular. The shape of a typical pore 701 appeared in the sample image shown in FIG. 5 is not circular. Further, although the periphery of a pore is surrounded by ridges in an actual fingerprint, in a scanned image of 500 dpi resolution, the outer periphery may be shown as being cut away since a part of a group of pixels surrounding a pore is digitized in low-dense which is similar level to a valley, as shown in an exemplary pore 702 in FIG. 5.

According to the flowchart of FIG. 4, in the pore extraction processing, first in step S301, a fingerprint image and a ridge density threshold table are loaded, and an initial value of the target pixel is set. Then, in step S302, it is determined whether processing has been completed to all pixels, and when completed, the processing proceeds to the next step.

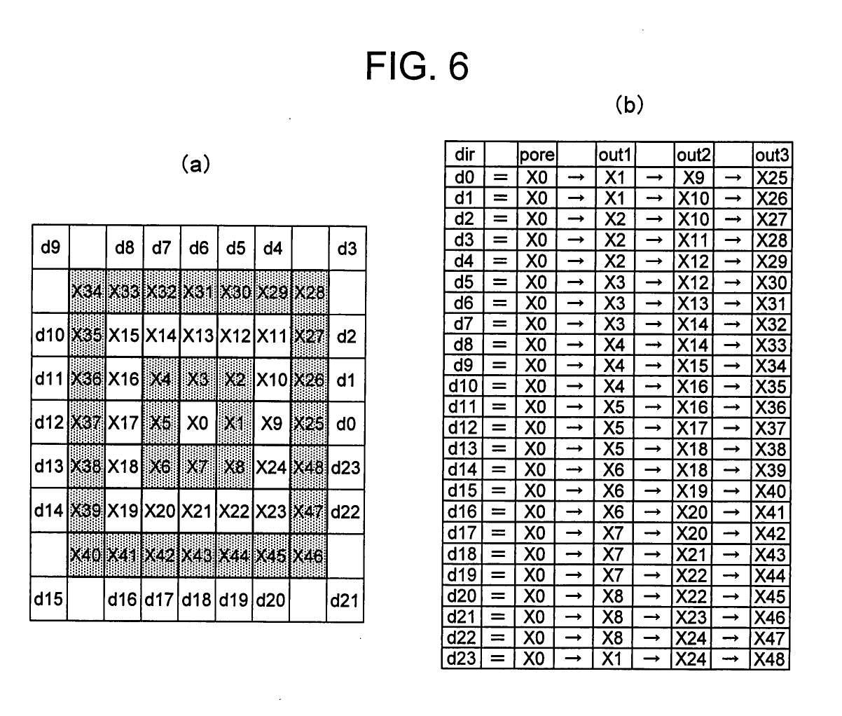

In step S303, an initial value of the radial mask is set. For example, a mask of 7*7 pixels around the target pixel, as shown in FIG. 6(a), is used as a radial mask. 49 pieces of constituent pixels of this mask have identification codes (ID) as shown. The target pixel is set to be X0, and a group of pixels just outside X0 is set such that the right side of X0 is X1, and codes from X2 to X8 are set in a counterclockwise direction. Further, a group of pixels located two-row outside X0 is set such that the right side of X1 is X9, and codes from X10 to X24 are set in a counterclockwise direction. Similarly, a group of pixels located three-row outside X0 is set such that the right side of X9 is X25, and codes from X26 to X48 are set in a counterclockwise direction.

The typical size of a pore in a 500 dpi scanned image is usually able to be expressed within a rectangle of 5*5 pixels. Therefore, in order to determine ridge pixels forming the outer periphery of the pore size, a mask size of 7*7 with a frame including one pixel for each of the top, bottom, right and left thereof, is determined. The mask size may be enlarged (e.g., 9*9 mask) to cope with a larger pore, but the amount of calculation increases.

Next, radial directions are set. To a group of pixels from X9 to X48 in 24 directions, radially linear directions drawn from the center X0 are set to d0 to d23. In FIG. 6(b), a group of pixel, located one-row outside the center pixel X0, is indicated as o1, a group of pixels located two-row outside is indicated as o2, and a group of pixels located three-row outside is indicated as o3, provided that “o” stands for “out”.

To the 24 directions, pixels through which each radial line passes are defined from the respective outside frames of three stages, one from each. The result is shown in FIG. 6(b). For example, it is defined that d0 is a direction starting from X0 and passing through X1, X9 and X25, d1 is a direction starting from X0 and passing through X1, X10 and X26, and the like. To these 24 directions, it is determined whether each radial line comes across a ridge pixel regarded as a ridge. If the pore comes across a ridge pixel, the ridge pixel is called an outer peripheral pixel.

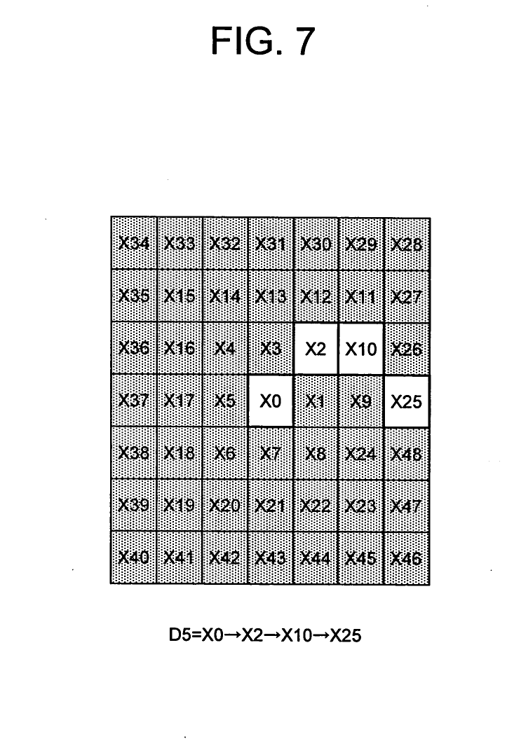

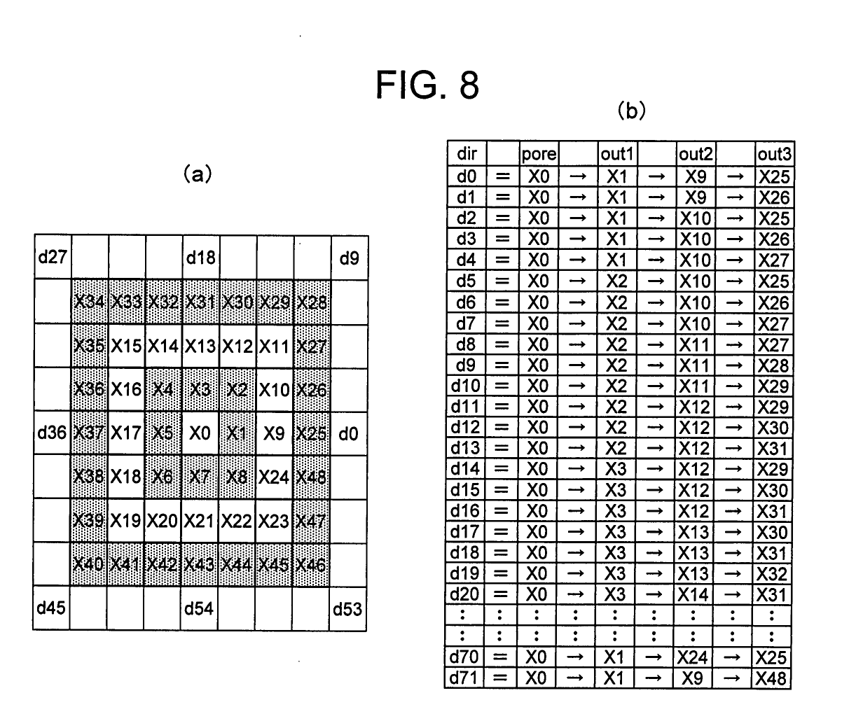

However, a case in which X0, X2, X10 and X25 are in sequence as shown in FIG. 7, is not defined in the 24 directions, so it cannot be determined whether to come across an outer peripheral pixel. Now, in order to inspect more detailed directions, 72 directions are defined as shown in FIGS. 8(a) and 8(b). In the 72 directions, a direction continuing from X0 to X2, X10 and X25 is defined as d5. According to this definition, although the amount of calculation increases, the accuracy of pore judgment improves. Therefore, the present embodiment uses 72 directions.

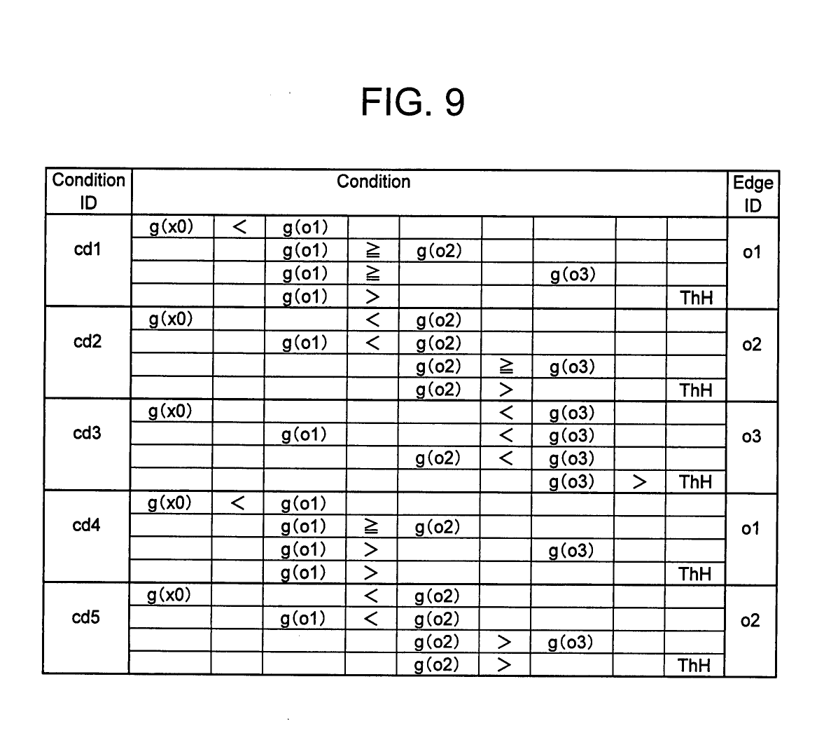

Next, in step S303, d0 is set as its initial value. In step S304, it is determined whether processing has been completed to all directions, and when completed, the processing proceeds to step S309. In step S305, it is inspected whether the pore conditions are satisfied. In this inspection, if the relationship between the center pixel X0 and the density of a pixel, located three-row outside defined for each target direction, satisfies the condition formula shown in FIG. 9, it is regarded as coming across the outer peripheral pixel shown on the right side (Edge ID).

For example, according to the first condition cd1 in FIG. 9, the density g(o1) of the pixel o1, which is one-row outside, is larger than the density g(X0) of the center pixel and is the same as or larger than the density g(02) of the pixel o2, which is two-row outside, and is same as or larger than the density g(03) of the pixel o3, which is three-row outside, and is larger than the ridge density threshold ThH, the pixel o1 is determined as the first pixel that the pore comes across a ridge. Note that since a group of pixels on the ridge side surrounding the pore are called outer peripheral pixels, the pixel o1 is an outer peripheral pixel in the direction.

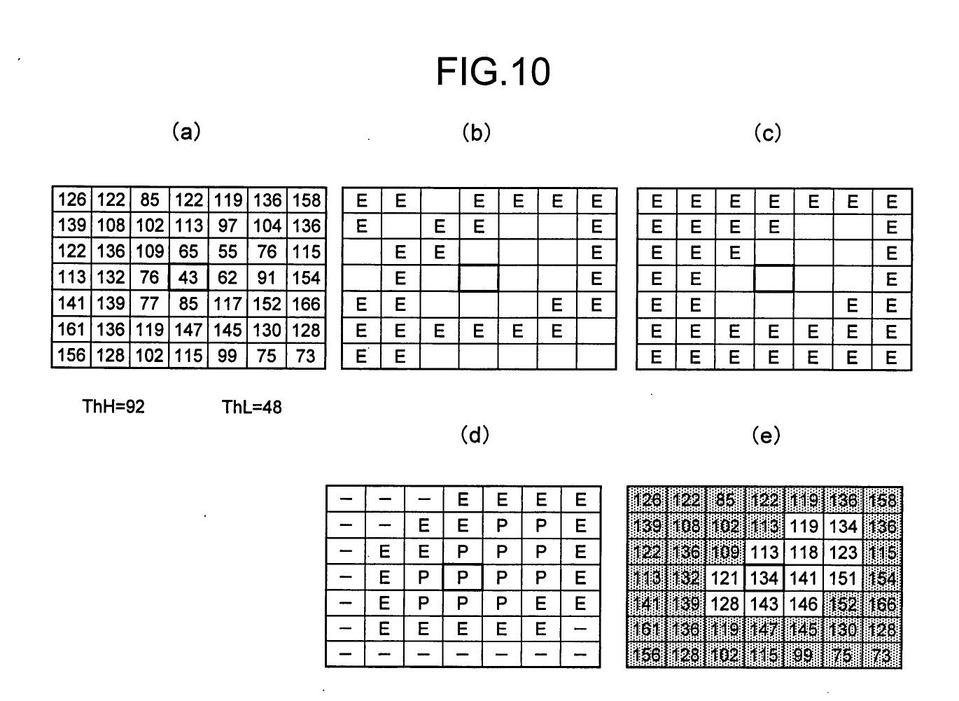

According to the fourth condition cd4 in FIG. 9, if the density g(o1) of the pixel o1, located one-row outside, is larger than the density g(X0) of the center pixel, and is the same as or larger than the density g(o2) of the pixel o2 located two-row outside, and is larger than the density g(o3) of the pixel o3 located three-row outside, and is larger than the ridge density threshold value ThL, the pixel o1 is determined as an outer peripheral pixel. This condition is for a case of having a peak in which the density values become larger from the target pixel toward outside and then become smaller. Here, even when the density of the peak pixel o1 is low, the pixel o1 is determined to have a high possibility of being an outer peripheral pixel, so it is judged by easing the condition of the ridge density threshold. For example, in an example with the density value of 7*7 pixel range as shown in FIG. 10(a), when the density change in a direction d19 (X0, X3, X13, X32) is inspected, the peak is found at X13, so X13 is also determined as an outer peripheral pixel.

In step S306, if the inspection result of step S305 coincides with any one of conditions in FIG. 9, the processing proceeds to step S307, and if it does not coincide with any of them, proceeds to step S308. In step S307, the outer peripheral pixel is determined, so the identification code (ID) of the pixel is registered in a pore outer peripheral pixel group table. FIG. 10(b) indicates such a group of outer peripheral pixels in a 7*7 mask.

In step S308, the direction currently processed has reached three-pixel outside without coming across an outer peripheral pixel. Therefore, according to the inspection result with respect to this direction, it is determined that the probability of the target pixel being a pore is small. If the density value of a group of pixels corresponding to this direction is low, the target pixel and the group of pixels in this direction are determined as a valley. Such a direction is defined as an open direction. In this case, the direction is registered in an open direction table. At the same time, a coordinate of the target pixel is also registered. This means that the open direction is associated with the target pixel (candidate for pore center pixel).

In step S309, radial inspection has been completed in all directions, and an open direction table at this point is loaded so as to inspect the presence of open directions and the number thereof. In the open direction inspection in the present embodiment, it is determined that no open direction exists when there is no open direction in principle. However, in the inspection in 72 directions, an open direction might appear even in a case of real pore. Therefore, when the number of open directions is not more than two for example, it can be determined as no open direction. In step S310, if it is determined that an open direction exists in the open direction inspection result, the processing proceeds to step S312. On the other hand, if it is determined that no open direction exists, the processing proceeds to step S311.

In step S311, pore pixels are determined in the following procedures. First, a group of pore outer peripheral pixels registered in step S307 is indicated on a 7*7 mask as shown in FIG. 10(b). This is explained by way of example using an image including pixel density values shown in FIG. 10(a). In this example, ridge density threshold values ThH and ThL are 92 and 48, respectively. A group of pore outer peripheral pixels registered in step S307 is a group of pixels marked with “E” in FIG. 10(b).

Next, all pixels outside the pore outer peripheral pixels defined with respect to respective radial directions are considered as outer peripheral pixels for the sake of convenience. Further, with respect to open directions, pixels on the outermost side are registered as pore outer peripheral pixels for the sake of convenience. As a result, the pore outer peripheral pixels form a group of pixels marked with “E” in FIG. 10(c).

Next, a group of pore pixels is determined. A group of pore pixels is easily determined as a group of pixels existing inside the group of pore outer peripheral pixels. As a result, the group of pore pixels form a group of pixels marked with “P” in FIG. 10(d). Next, a group of pore pixels defined in this manner is registered in a pore table. In the pore table, the target pixel is registered as a pore center pixel, and a group of pore pixels, other that the center pixel, found in the inspection performed radially from the center pixel is registered so as to be associated with the pore center pixel.

Next, a group of pore outer peripheral pixels is defined finally. A group of outer peripheral pixels contacting a group of pore pixels determined in the above-described manner with four-neighborhood connection is defined as a final group of pore outer peripheral pixels. The four-neighborhood connection means a state in which with respect to a black pixel, any one of four neighboring pixels adjacent thereto in top, bottom, right and left directions includes a black pixel, whereby connection is capable. As a result, a final group of pore outer peripheral pixels is a group of pixels marked with “E” in FIG. 10(d). Next, a group of pore outer peripheral pixels determined in this manner is registered in the pore table. In the pore table, the pore center pixel has been registered, and the group of pore outer peripheral pixels is registered while being associated with the pore center pixel.

Next, in step S312, since processing of the current target pixel has been completed, the next pixel is set and the processing is back to step S302. The next pixel may be a pixel adjacent the current target pixel. Note that a group of pore pixels extracted around one target pixel and a group of pore pixels extracted around a pixel near the target pixel may coincide with each other. In order to simplify the processing, the present embodiment is so described that a group of pore pixels is determined with respect to each pixel, and are not integrated with a group of pore pixels corresponding to a near pixel.

Next, as shown in step S3 in FIG. 1[2], a group of pore pixels extracted in step S2 is inspected, and only those determined as pores are selected. This processing is performed by the pore selecting means 18 in FIG. 1[1]. The pore selecting means 18 loads the pore table and the open direction table extracted by the pore extracting means 17, and selects pore based on the predetermined rule. In the present embodiment, if there is at least one open direction, it is determined not to be appropriate for a pore and the corresponding group of pore pixels is deleted. However, in the inspection in 72 directions, since there is a case where an open direction appears even for an actual pore, it may be judged as no open direction if there are, for example, two or less open directions for the sake of convenience. If the judgment result is the same as that in step S2, processing of step S3 may not be performed.

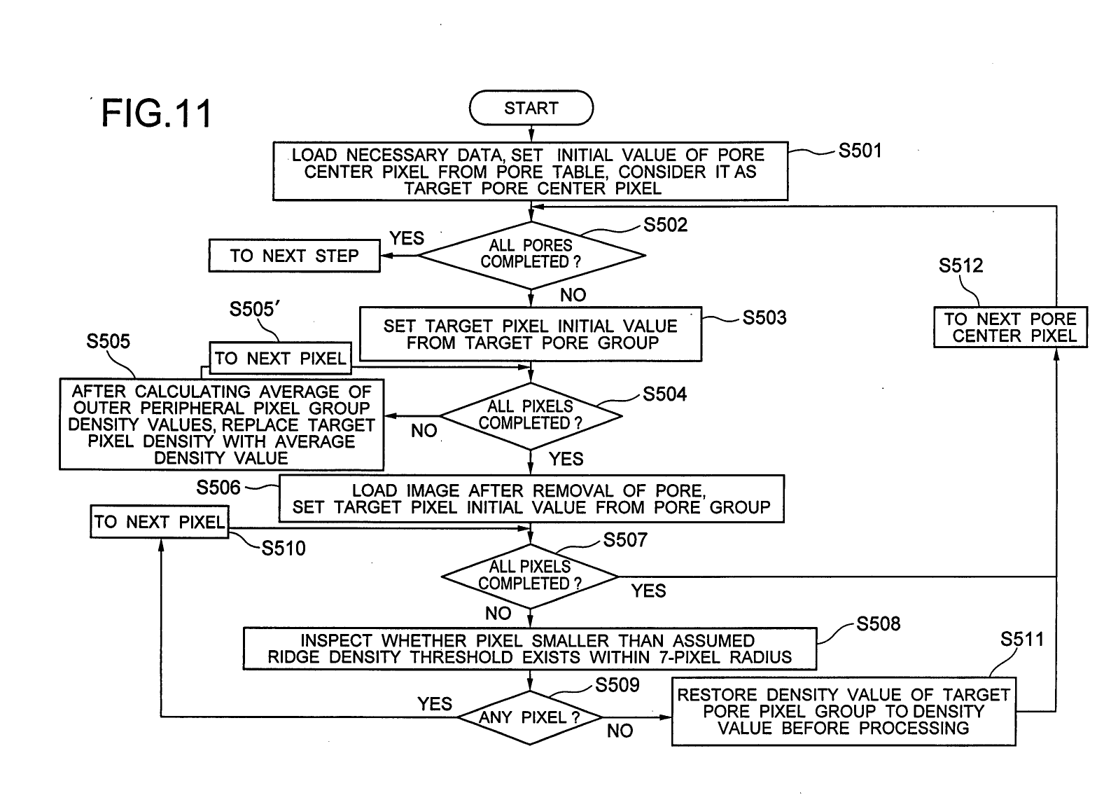

Next, as shown in step S4 in FIG. 1[2], removal of a pore is tried by using a group of pore pixels selected in step S3, and if the result is appropriate as a fingerprint ridge, it is adopted. This processing is performed by the pore removing means 19 in FIG. 1[1]. The pore removing means 19 loads a fingerprint gray image and the pore table selected by the pore selecting means 18, and changes the density value of a group of pore pixels to thereby remove the pore. The pore removing processing adopted in the present embodiment will be explained by using a flowchart in FIG. 11.

According to the flowchart in FIG. 11, first in step S501, a fingerprint image and the pore table outputted in step S3 are loaded, and the first pore center pixel on the pore table is set as an initial value, and is set as a center pixel of the target pore. In step S502, it is determined whether processing has been completed to all center pixels of pores on the pore table, and when completed, processing proceeds to the next step.

In general, there are a plurality of groups of pore pixels with respect to the center pixel of the target pore. In step S503, a pixel to be processed first with respect to the group of pore pixels is set, and is set as a target pixel B. In step S504, it is determined whether processing has been completed with respect to all pixels in the group of pore pixels. If it has not been completed, the processing proceeds to step S505, and when completed, the processing proceeds to step S506.

In step S505, a weighted average is calculated by using density values of a group of pore outer peripheral pixels near the target pixel B. Here, an inverse number of the distance is adopted as weighting. Consequently, if the distance is nearer, the weighting increases, whereby the influence on the weighted average value becomes larger. All pixels may be adopted as a group of pore outer peripheral pixels near the target pixel B. However, in the present embodiment, tracing is performed from the target pixel B in upward, downward, right and left directions, and only outer peripheral pixels which come across first in respective directions are used, in order to reduce the amount of calculation. When this weighted average value is larger than the density value of the target pixel B, the density value of the target pixel B is replaced with the weighted average value.

For example, a pixel X1 in FIG. 10(a) has the original density value of 62. The result of calculating the weighted average of the four density values 132, 145, 154, 119 of the outer peripheral pixels X17, X22, X25 and X30 is 141. This value is larger than the original density value, so it is replaced. The weighted average at this time is given by ( 1/3*132+ 1/2*145+ 1/2*154+ 1/3*119)/(⅓+½+½+⅓)≈0.141. As a result of this processing, the density values of FIG. 10(a) are replaced as shown in FIG. 10(e), whereby the pore is removed.

Next, the result of pore removal is briefly inspected whether it is appropriate as a fingerprint ridge. According to this inspection, if the ridge width with respect to the image after removing the pore is considerably larger than the average ridge width, the result is determined as inappropriate. In the present embodiment, since a ridge direction is not extracted, the determination is performed by using the diameter of a group of pixels, regarded as a ridge, as a ridge width. The detailed procedure will be explained by using a flowchart in FIG. 11.

In step S506, the image after removing the pore is loaded, and a pixel to be processed first with respect to a group of pore pixels is set, and is set as a target pixel B. In step S507, it is determined whether processing has been completed to all pixels of a group of pore pixels associated with the center pixel of the pore. If it has not been completed, the processing proceeds to step S508, and if completed, the processing proceeds to step S512 without discarding pore removal processing since the pore removal processing is appropriate.

In step S508, it is determined whether there is a pixel regarded as a valley in a group of pixels within 7 pixels near the target pixel B. If the density value is less than ThL, it is determined as a valley. Here, the length of 7 pixels is set as 70 percents of the average ridge length of 10 pixels, and in the case of typical fingerprint ridge part, it is assumed that a valley exists in this range (±15 pixels).

In step S509, if there is a pixel determined as a valley, the processing proceeds to step S510, and if there is no pixel determined as a valley, proceeds to step S511. In step S510, since the pore removal processing is appropriate, the next pixel is taken out from a group of pore pixels, which is set as a target pixel B and the processing is back to S507. In step S511, since the pore removal processing is inappropriate, the pore removal processing of a group of pore pixels associating with the center pixel of the target pore is discarded, and the density value is restored to that of the original image. As a result, a gray image from which a pore is removed is outputted. The explanation about the first embodiment ends.

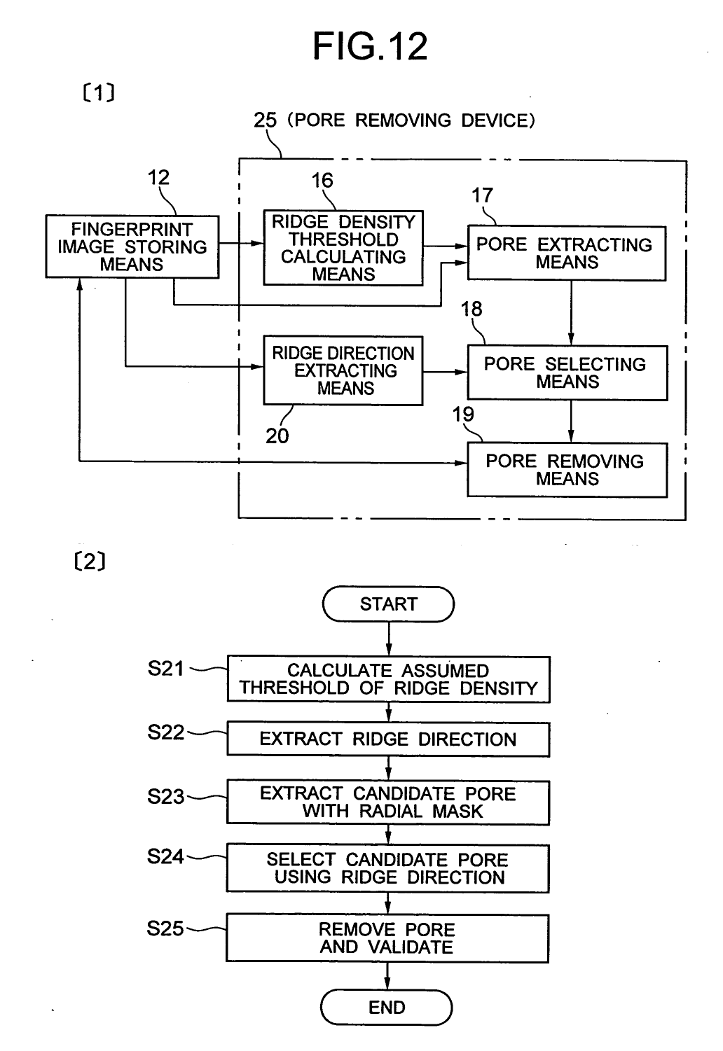

FIGS. 12[1] and 12[2] show a second embodiment of a pore removing device according to the present invention, in which FIG. 12[1] is a block diagram, and FIG. 12[2] is a flowchart. Hereinafter, explanation will be given referring mainly to these Figures. However, explanation for the same parts as those in the first embodiment is omitted.

A pore removing device 25 of the present embodiment includes, a ridge density threshold calculating means 16, a pore extracting means 17, a pore selecting means 18, a pore removing means 19, and further, a ridge direction extracting means 20. The device 25 is so configured that when a pore is extracted and removed from a fingerprint image stored on the fingerprint image storing means 12, the accuracy of sweat grand extraction is further improved by using a ridge direction. Note that “ridge direction detecting means” described in claims corresponds to the ridge direction extracting means 20, and a part of the function of “pore judging means” corresponds to the pore selecting means 18. Further, respective means of the pore removing device 25 are realized on a computer by programs.

The ridge direction extracting means 20 extracts a direction of a ridge based on the changes in the fingerprint image densities near the target pixel, by a small area unit. The pore selecting means 18 of the present embodiment compares open direction information extracted by the pore extracting means 17 with ridge direction information extracted by the ridge direction extracting means 20, and selects only those satisfy the predetermined conditions. In other words, the present embodiment is different from the first embodiment in that a ridge direction is extracted and a pore is selected based on the information.

First, in step S21, an assumed threshold of the ridge density is calculated. This calculation is performed by the ridge density threshold calculating means 16, and the method is the same as that in the first embodiment.

Next, in step S22, a ridge direction is extracted. This extraction is performed by the ridge direction extracting means 20. The ridge direction of a fingerprint is automatically extracted by a conventional technique disclosed in Japanese Examined Patent Publication No. 59-27945, for example. That is, by using the fact that in an image including a stripe pattern the density fluctuation is small in a direction same as the stripe and is large in a direction orthogonal to the stripe, the extreme values of the fluctuation amounts of the densities with respect to a plurality of predetermined quantizing directions are calculated, from which the direction of stripe is determined.

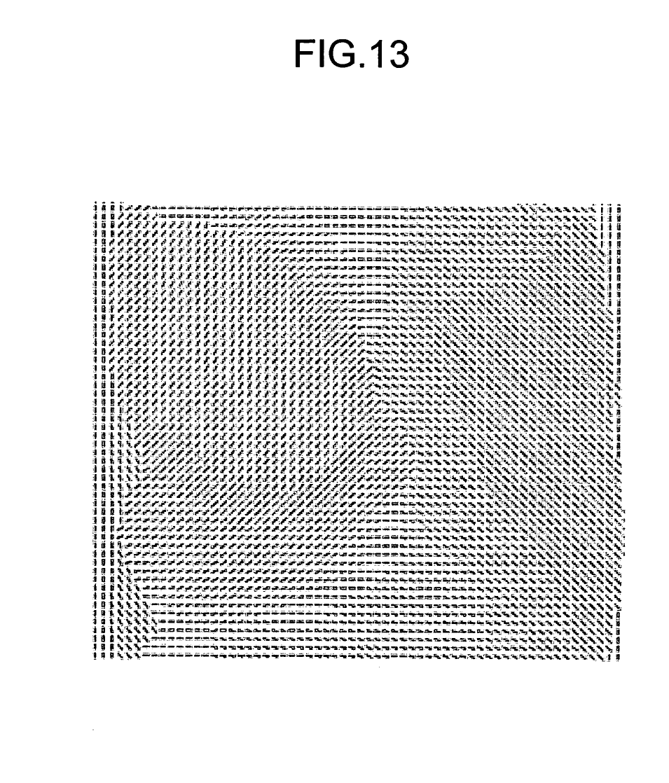

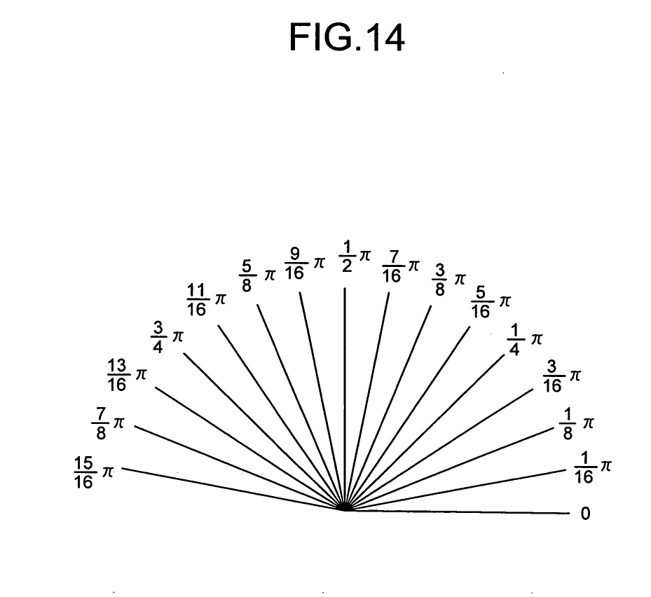

FIG. 13 shows the result of extracting a direction by means of a method disclosed in Japanese Examined Patent Publication No. 59-27945, with respect to the fingerprint image in FIG. 3. In FIG. 13, ridge directions are indicated in 16 directions as shown in FIG. 14 with respect to a small area of 8-pixel square.

Next, in step S23, a candidate pore is extracted by using a radial mask. This extraction is performed by the pore extracting means 17, and is basically the same as that in the first embodiment. The difference from the first embodiment is a judgment of an open direction in step S309 of FIG. 4. In the present embodiment, a pore is determined by inspecting the inner angle between a ridge direction and an open direction. Therefore, even when there are some open directions, it is determined as no open direction for the sake of convenience. For example, in the case of radial inspection in 24 directions, it is determined as no open direction when the number of open directions is two or less, and in the case of radial inspection in 72 directions, it is determined as no open direction when the number of open directions is six or less, for the sake of convenience.

Next, in step S24, a group of pore pixels extracted in step S23 is inspected, and only those determined as pore are selected. This processing is performed by the pore selecting means 18. The pore selecting means 18 loads not only the pore table and the open direction table extracted by the pore extracting means 17 but also ridge directions extracted by the ridge direction extracting means 20, and selects a pore based on the predetermined rule.

In the radial inspection in 24 directions, if there are more than two open directions, the group of pixels is determined to be inappropriate as a pore. Even when the open directions are two or less, if one direction is determined to be almost parallel with the ridge direction, the group of pixels is determined to be inappropriate as a pore. In the present embodiment, the inner angle between an open direction and a ridge direction is calculated, and when the inner angle is less than 45 degrees, they are determined as almost parallel.

In the radial inspection in 72 directions, if there are more than six open directions, the group of pixel is determined to be inappropriate as a pore. Even when the open directions are six or less, if one direction among them is determined to be parallel with the ridge direction, the group of pixel is determined to be inappropriate as a pore. If determined to be inappropriate, the group of pore pixels and a group of pore outer peripheral pixels are eliminated from the pore table.

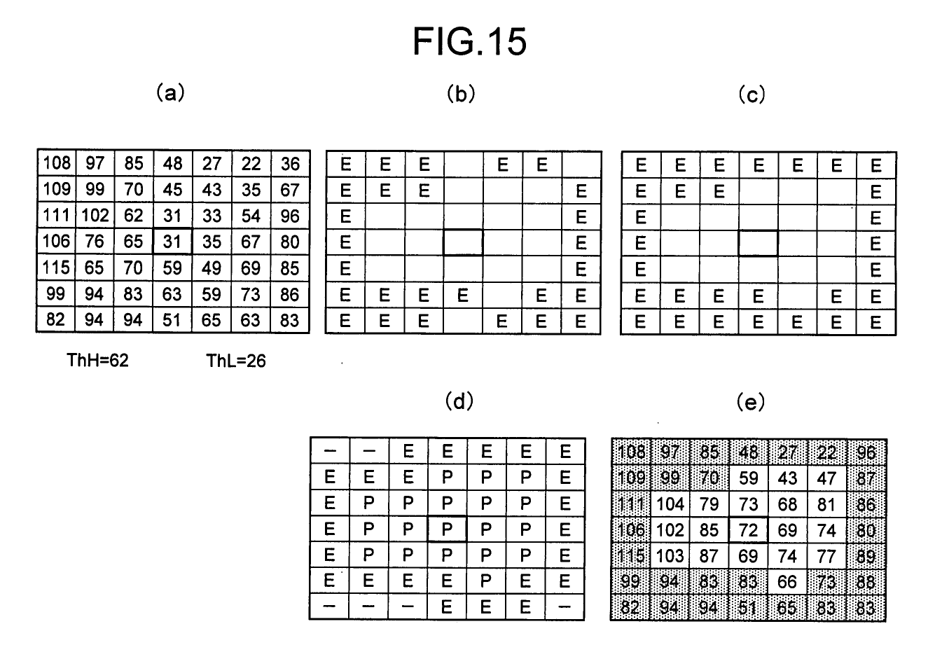

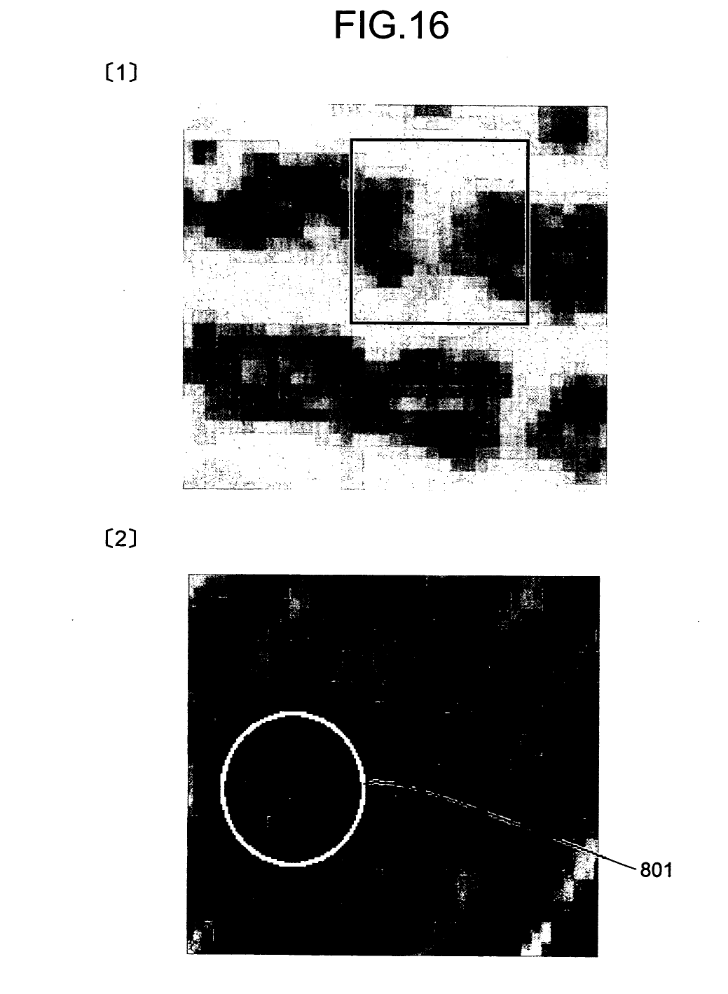

For example, an exemplary pore in FIG. 16[1] will be explained. The density values of a 7*7 mask around the pore are shown in FIG. 15(a). When the group of pixel is inspected radially, five directions, that is, d9, d13, d16, d18 and d56 are extracted as open directions. Since a ridge direction near this part is d33, all inner angles to the open directions are 45 degrees or more. Therefore, in this example, the group is determined to be appropriate as a pore.

Next, in step S25, removal of the pore is tried by using the group of pore pixels selected in step S24, and if the result is appropriate as a fingerprint ridge, it is adopted. This processing is performed by the pore removing means 19, and is basically the same as that of the first embodiment. The difference is that since the ridge direction is known in the present embodiment, inspection of ridge width is required only for directions orthogonal to the ridge direction, so there is no need to perform inspection for all directions.

FIGS. 15(b), 15(c), 15(d) and 15(e) show results of processing the pore shown in FIG. 16[1] by using the present embodiment.

Needless to say, the present invention is not limited to the first and second embodiments described above. Although explanation has been given by using examples such as a radial pore extraction mask and various parameters on the premise of a 500 dpi fingerprint image typically adopted, the present invention can be applied to fingerprint images scanned with resolutions other than 500 dpi, by using masks and parameters appropriate for such resolutions. Further, in the second embodiment, a ridge direction extracting means may be included in the configuration of a minutia extracting means. In such a case, the pore removing device inputs a ridge direction together with a fingerprint gray image.

### INDUSTRIAL AVAILABILITY

The processing object of the present invention is not limited to a fingerprint image. The present invention is applicable to images constituted from ridges having similar shapes as pores such as a palm print image.

1. A pore removing device for removing a pore from a fingerprint gray image when extracting a minutia from the fingerprint gray image, comprising:
ridge pixel detecting means for detecting a presence of a ridge pixel in each radial direction from a target pixel as a center thereof based on a density change, with respect to a group of pixels in a certain area including the target pixel within the fingerprint gray image; and
pore judging means for, according to a result detected by the ridge pixel detecting means, considering the ridge pixel, if any, as a peripheral pixel, and if there is no ridge pixel, considering such a direction as an open direction defined by a valley, and based on a total number of the open directions, judging whether the target pixel is the pore.

2. The pore removing device, as claimed in claim 1, wherein the ridge pixel detecting means detects a pixel having a density value not less than a certain level as the ridge pixel.

3. The pore removing device, as claimed in claim 2, wherein when the density change shows a density value peak in which the density value once increases along the direction and then decreases, the ridge pixel detecting means detects a pixel with the density value peak as the ridge pixel.

4. The pore removing device, as claimed in claim 1, wherein the pore judging means judges the target pixel as the pore if the total number of the open directions is zero or not more than a certain number.

5. The pore removing device, as claimed in claim 1, further comprising, pore removing means for, when the target pixel is judged as the pore by the pore judging means, considering a pixel inside the peripheral pixels as a pore pixel, and replacing a density of the pore pixel with a density close to the densities of the peripheral pixels.

6. The pore removing device, as claimed in claim 5, wherein the pore removing means replaces the density of the pore pixel with an average value of the densities of the peripheral pixels weighted, weighting being heavier as a distance to the target pixel is shorter.

7. The pore removing device, as claimed in claim 5, wherein after the density of the pore pixel is replaced, the pore removing means restores the replaced density if an area regarded as the ridge pixel is not less than a certain width.

8. The pore removing device, as claimed in claim 1, further comprising, ridge direction detecting means for detecting a ridge direction, wherein the pore judging means judges the target pixel as the pore if an inner angle defined by the ridge direction detected by the ridge direction detecting means and the open direction is not less than a certain angle.

9. A pore removing method for removing a pore from a fingerprint gray image when extracting a minutia from the fingerprint gray image, comprising the steps of:
detecting a presence of a ridge pixel in each radial direction from a target pixel as a center thereof based on a density change, with respect to a group of pixels in a certain area including the target pixel within the fingerprint gray image; and
according to a result detected by the step of detecting a presence of a ridge pixel, considering the ridge pixel, if any, as a peripheral pixel, and if there is no ridge pixel, considering such a direction as an open direction defined by a valley, and based on a total number of the open directions, judging whether the target pixel is the pore.

10. A pore removing program, used for removing a pore from a fingerprint gray image when extracting a minutia from the fingerprint gray image, for prompting a computer to execute: a function of detecting a presence of a ridge pixel in each radial direction from a target pixel as a center thereof based on a density change, with respect to a group of pixels in a certain area including the target pixel within the fingerprint gray image; and
according to a result detected by the step of detecting a presence of a ridge pixel, a function of considering the ridge pixel, if any, as a peripheral pixel, and if there is no ridge pixel, considering such a direction as an open direction defined by a valley, and based on a total number of the open directions, judging whether the target pixel is the pore.
